(19) United States
(12) Patent Application Publication
(10) Pub. No.: US 2015/0195434 A1
(43) Pub. Date: Jul. 9, 2015

(54) THREE-DIMENSIONAL FACE SCANNING APPARATUS

(71) Applicant: ELECTRONICS AND TELECOMMUNICATIONS RESEARCH INSTITUTE, DAEJEON (KR)

(72) Inventors: Soon-Young KWON, Daejeon (KR); Jin-Seo KIM, Daejeon (KR); Ji-Hyung LEE, Daejeon (KR); Song-Woo LEE, Daejeon (KR); Jae-Woo KIM, Daejeon (KR); Ju-Yeon YOU, Daejeon (KR); In-Su JANG, Daejeon (KR); Yoon-Seok CHOI, Daejeon (KR)

(73) Assignee: ELECTRONICS AND TELECOMMUNICATIONS RESEARCH INSTITUTE, DAEJEON (KR)

(21) Appl. No.: 14/228,144

(22) Filed: Mar. 27, 2014

(30) Foreign Application Priority Data
Jan. 6, 2014 (KR) 10-2014-0001469

(51) Int. Cl. H04N 5/225; H04N 5/28; G06K 9/00; H04N 13/02

(52) U.S. Cl. CPC H04N 5/2252; H04N 13/0253; H04N 13/0275; H04N 13/0296; H04N 5/28; G06K 9/00255

(57) ABSTRACT

A three-dimensional (3D) face scanning apparatus is provided. The 3D face scanning apparatus includes a housing body configured to comprise a darkroom formed inside, and a face positioning part with an opening in front of the darkroom, allowing a user's face to be placed in the darkroom therethrough; a camera module installed at a rear of the darkroom to capture stereo images of the user's face; and a lighting module installed in the darkroom to illuminate the face. The 3D face scanning apparatus enables an ordinary user to easily perform 3D face scanning, and has improved mobility due to its compact structure.

### CROSS-REFERENCE TO RELATED APPLICATION(S)

This application claims priority from Korean Patent Application No. 10-2014-0001469, filed on Jan. 6, 2014, in the Korean Intellectual Property Office, the disclosure of which is incorporated herein by reference in its entirety.

### BACKGROUND

1. Field

The following description relates to a three-dimensional (3D) scanning apparatus, and more particularly, to a 3D face scanning apparatus to obtain a 3D model of a human face.

2. Description of the Related Art

Many researches on modeling and rendering to acquire a three-dimensional (3D) representation of a human face have been conducted. 3D face information is used in various computer vision applications, such as face recognition, facial expression recognition, and face modeling.

Since a human face is three-dimensional, nonlinear and angular, images obtained by applying a 3D rotation to a face may show significantly varying face shapes, and different facial expressions may lead to different face shapes with respect to the same facial pose. Thus, predicting a 3D face shape from two-dimensional images is important in various computer vision applications, such as face or facial expression recognition and image modeling.

One method of building a 3D face model is to reconstruct a 3D face model by capturing several images of a face. In this case, a device to capture a number of photos of a face at one time is necessary. Especially, to reflect an exact skin color of a user to a 3D model, images may need to be captured by an expert under controlled environment and lighting conditions. According to the related art, devices to reconstruct a 3D face model based on photos may have a large size, and have difficulties in reproducing the exact face skin color due to the influence of external lighting.

### SUMMARY

The following description relates to a three-dimensional (3D) face scanning apparatus allowing an ordinary user to easily carry out 3D face scanning, and having a compact structure that improves mobility.

In one general aspect, there is provided a three-dimensional (3D) face scanning apparatus including: a housing body configured to comprise a darkroom formed inside, and a face positioning part with an opening in front of the darkroom, allowing a user's face to be placed in the darkroom therethrough; a camera module installed at a rear of the darkroom to capture stereo images of the user's face; and a lighting module installed in the darkroom to illuminate the face.

Other features and aspects will be apparent from the following detailed description, the drawings, and the claims.

### BRIEF DESCRIPTION OF THE DRAWINGS

FIG. 1 is a perspective view of a three-dimensional (3D) face scanning apparatus according to an exemplary embodiment.

FIG. 2 is a cross-sectional view of the 3D face scanning apparatus of FIG. 1.

FIG. 3 is an exploded perspective view of the 3D face scanning apparatus of FIG. 1.

FIG. 4 is a perspective view illustrating an air flow in the 3D face scanning apparatus of FIG. 1.

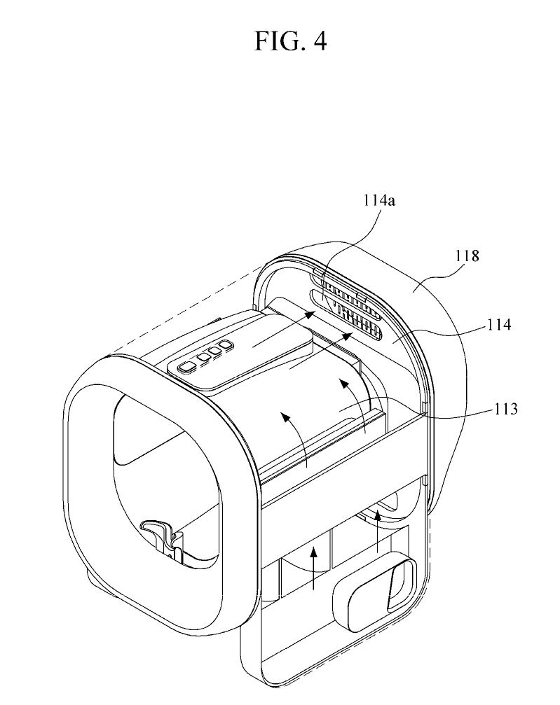

FIG. 5 is a front view of the 3D face scanning apparatus of FIG. 1.

FIG. 6 is a front view of an example of a face positioning part with a face screen of FIG. 1.

FIG. 7 is a front view showing an example of use of the face screen shown in FIG. 6.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

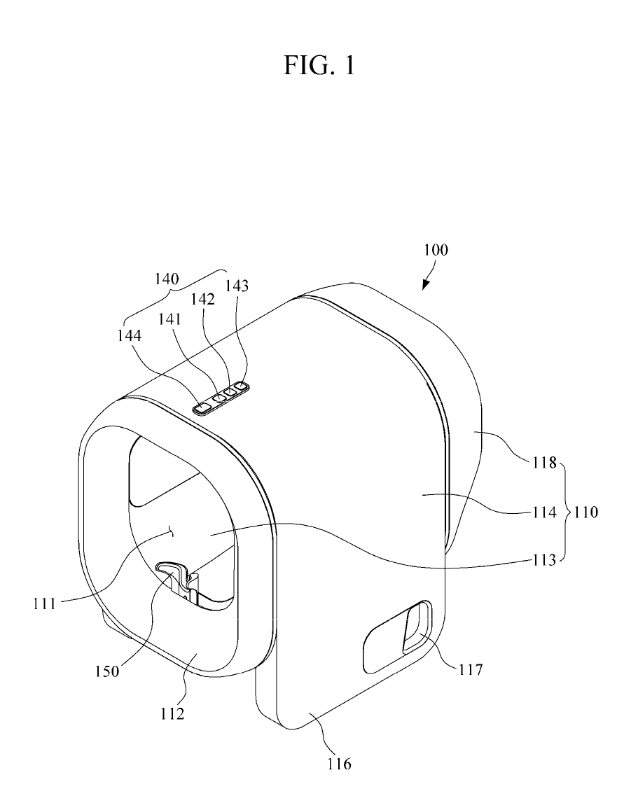

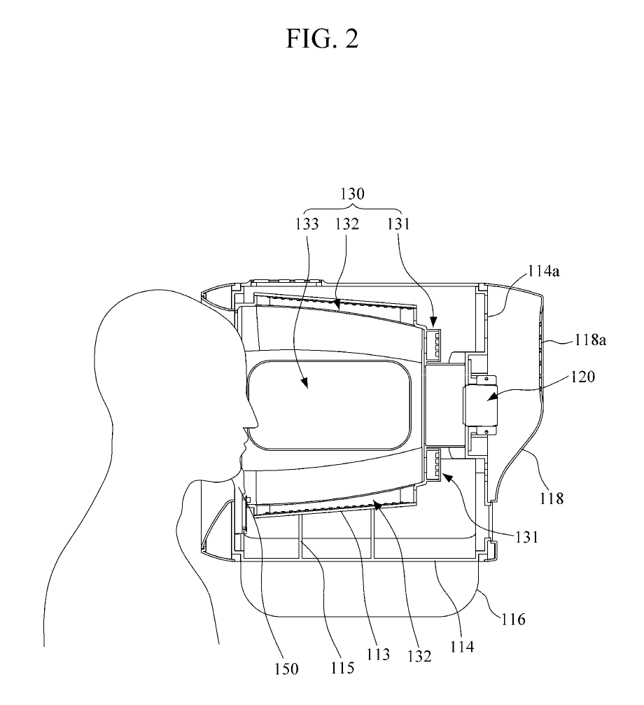

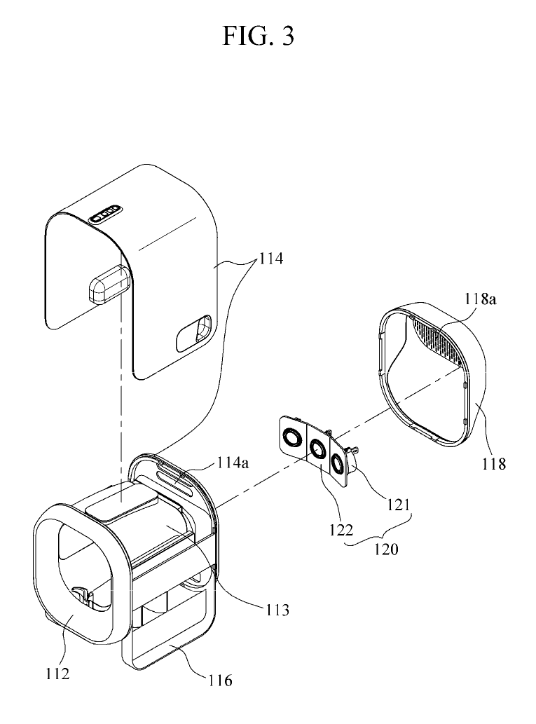

FIG. 1 is a perspective view of a three-dimensional (3D) face scanning apparatus according to an exemplary embodiment. FIG. 2 is a cross-sectional view of the 3D face scanning apparatus of FIG. 1. FIG. 3 is an exploded perspective view of the apparatus of FIG. 1.

Referring to FIGS. 1 to 3, the 3D face scanning apparatus 100 includes a housing body 110, a camera module 120, and a lighting module 130.

The housing body 110 includes a darkroom 111 formed therein. The housing body 110 includes a face positioning part 112 formed in the front of the darkroom 111, open to the outside to allow a user's face to put thereon. All walls of the darkroom 111, other than the front side, may be closed. Therefore, when the user's face is placed on the face positioning part 112, it may be possible to block all light to the darkroom 111.

The face positioning part 112 has an opening, enabling the user to put his/her face into the darkroom 111. The opening of the face positioning part 112 may fit an average-sized human head. The opening of the face positioning part 112 may have a similar shape as a human face. For example, the face positioning part 112 may be a rectangular shape with widely rounded corners. The face positioning part 112 may protrude outward from the front of the darkroom 111. The face positioning part 112 may have an entrance wider than an exit, enclosing the user's face. The user may rest and secure the face in the face positioning part 112.

For example, the housing body 110 may include an interior housing 113 and an exterior housing 114. The interior housing 113 includes the darkroom 111 formed inside. The interior housing 113 may have a top surface that has a curved slope descending toward the rear of the interior housing 113. Accordingly, air rising up to the top surface of the interior housing 113 due to convection currents can smoothly move along the top surface to the rear of the interior housing 113. A bottom surface of the interior housing 113 may have a curved slope rising toward rear of the interior housing 113.

The exterior housing 114 may be formed in a shape that encloses the interior housing 113 at a distance. A plurality of ribs 115 extrude from an inner lower surface of the exterior housing 114 to support the interior housing 113. The exterior housing 114 includes a first vent opening 114a. The first vent opening 114a may be formed on the rear surface of the exterior housing 114 to be higher than the top surface of the interior housing 113. Due to convection currents, air at the bottom of the interior housing 113 moves up the side walls to the top surface of the interior housing 113, and then flows out through the first vent opening 114a. As will be described later, the camera module 120 may include a plurality of cameras 121, and the lighting module 130 may include an ultraviolet lamp and several tens of light emitting diodes (LEDs), and in this case, a large amount of heat may be produced during operation. Air flows through a space between the interior housing 113 and the exterior housing 114 and escapes through the first vent opening 114a, which may facilitate heat exhaust.

The exterior housing 114 may include support legs 116 on the left and right sides. The apparatus 100 may be placed on a table, and the user may sit on a chair and put the face into the apparatus 100. In this case, the height of support legs 116 may be set to be high enough for the user to put the face on the face positioning part 112 in a comfortable position, by taking into account the location of the user's face. Each of the support legs 116 may have a handle 117 provided thereon. Each handle 117 may be a groove recess having a dent in a surface of the support leg 116.

The housing main body 110 may include a rear housing 118 that is installed in the rear of the exterior housing 114, and accommodates the camera module 120. The rear housing 118 includes a second vent opening 118a. The air flowing out through the first vent opening 114a escapes to the outside through the second vent opening 118a. The second vent opening 118a may be formed on a top area of the rear housing 118. The rear housing 118 may be formed of a transparent or translucent light transmitting material. Accordingly, when errors of some cameras 121 are indicated by means of a malfunction indicator light or display of the cameras 121, the user can easily recognize the errors through the rear housing 118.

The camera module 120 installed in a rear surface of the darkroom 111 captures a stereo image of the user's face. The camera module 120 includes a plurality of cameras 121 to reconstruct a three-dimensional image of the face from stereo or multi-stereo images. The cameras 121 may be arranged horizontally. If there are three cameras 121, the cameras 121 may be arranged in such a manner that a lens of the middle camera is directed toward the center of the face, and lenses of the cameras on the left and right sides are angled toward the center of the face. The lenses of the left and right cameras 121 may be turned at an angle set to be suitable for capturing optimized images for 3D face reconstruction. In addition, positions of the cameras 121 may be determined by taking into consideration a size of an image sensor, an angle of view of a lens, and the like.

The cameras 121 may be supported, respectively, by camera supports 122 with the aid of holders while the lenses of the cameras 121 pass through the respective camera supports 122. The camera supports 122 may be fixed on the rear surface of the interior housing 113. The camera supports 122 may be a generally oval-shaped planar member.

The cameras 121 are capable of capturing images of the face at different angles. Thus, the images captured by the cameras 121 may have disparity, and it is possible to reconstruct 3D face using disparity information. In this example, there are three cameras 121, but the aspects of the embodiment are not limited thereto, such that two or four, or more, cameras may be provided. The images captured by the cameras 121 are provided to an operating system, and the operating system performs 3D modeling of the images using 3D reconstruction software. The operating system may be a computer-based system.

The lighting module 130 may be installed in the darkroom 111 to illuminate the face. The lighting module 130 may include general light sources 131, polarized light sources 132, and ultraviolet (UV) light sources 133. The general light sources 131 emit general light into the darkroom 111. The general light sources 131 are mounted in the rear surface of the darkroom 111, and are placed above and below the camera module 120. The general light sources 131 emit the general light toward the front of the darkroom 111. The cameras 121 may capture images of the face illuminated by the general light from the general light sources 131. A 3D face model is built from the images captured by the cameras 121.

The general light sources 131 may include a plurality of light emitting diodes (LEDs) and diffuser panels placed in front of the plurality of LEDs. The LEDs may be mounted on a board. The interior housing 113 may include an accommodating part to situate the general light sources 131. The diffuser panels may be installed on the interior housing 113 and be exposed to the darkroom 111. The light emitted from the LEDs may be evenly dispersed over the darkroom 111 by the diffuser panels.

The polarized light sources 132 emit polarized light into the darkroom 111. The polarized light sources 132 are mounted at locations corresponding to the top surface and bottom surface of the darkroom 111, and emit polarized light into the darkroom 111. When images of the face are captured by the cameras 121 while the face is illuminated with the polarized light, glare due to specular reflection may be prevented in the captured images.

The polarized light sources 132 may include a plurality of LEDs and polarization filters placed in front of the LEDs. The LEDs may be mounted on a board. The polarization filters produce polarized light from light emitted from the LEDs. The interior housing 113 may include accommodating parts at the top and bottom surfaces to situate the polarized light sources 132. The polarized light sources 132 may be installed on the interior housing 113 in such a manner that a light transmitting plate of each polarized light source 132 is exposed within the darkroom 111.

The UV light sources 133 emit UV light into the darkroom 111. The UV light sources 133 may be placed at positions corresponding to left and right sides of the darkroom 111, and may emit UV light into the darkroom 111 from the sides. If images of the face are captured by the cameras 121 while the face is illuminated with the UV light, skin conditions, such as sunspots and freckles on the face, may also be determinable from the captured images. Hence, these images can be used for skin analysis.

The UV light sources 133 may include UV lamps. Since the UV lamps generally generate an insufficient amount of light, the UV lamps may be arranged at positions corresponding to the left and right sides of the face where acquisition of the required amount of light is easier. The interior housing 113 may include an accommodating part at each of the left and right sides upon which to situate the UV light sources 133. The UV light sources 133 may be installed in such a manner that a light transmitting plate of each UV light source 133 is exposed within the darkroom 111.

As described above, the 3D face scanning apparatus 100 may enable an ordinary user to easily perform 3D face scanning Also, the compact structure of the 3D face scanning apparatus 100 may increase the mobility of the apparatus.

An operating part 140 may be disposed on an outer side of the housing body 110. The operating part 140 may include: a general light source button 141 to switch on and off the general light sources 131; a polarized light source button 142 to switch on and off the polarized light sources 132; a UV light source button 143 to switch on and off the UV light sources 133; and a power button 144. An operator or a user may selectively switch on or off any of the general light sources 131, the polarized light sources 132, and the UV light sources 133.

The operating part 140 may be mounted on a top outer surface of the exterior housing 114. In so doing, an operator may easily access and operate the 3D face scanning apparatus 100 with the operating part 140 while the user puts his/her face in the 3D face scanning apparatus 100. In this way, the most efficient scanning operation using the 3D face scanning apparatus 100 may be possible.

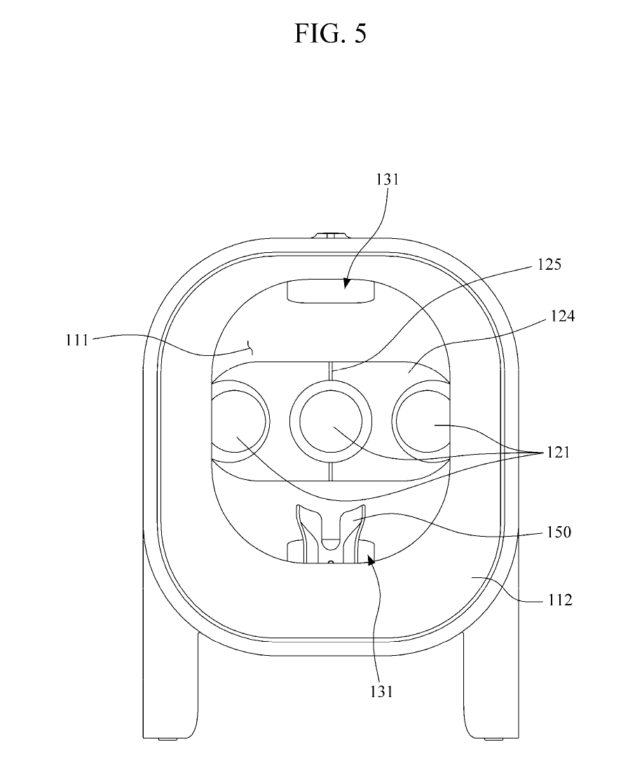

Referring to FIG. 5, a mirror 124 may be placed on an inner rear side of the darkroom 111. The mirror 124 is disposed toward the front of the darkroom 111. In a case where a transparent panel penetrating the rear side of the darkroom 111 is provided, the mirror 124 may be formed on the whole of one surface of the transparent panel, excluding areas that correspond to locations of the camera lenses. The mirror 124 may have guiding lines 125 in the center. The guiding lines 125 may be vertical lines centrally placed at the top and bottom of the lens of the middle camera 121. The user may check and align the position of the face while viewing the reflection of the face on the mirror 124 and the guiding lines 125.

The face positioning part 112 includes a jaw rest 150 to support the user's jaw. The jaw rest 150 may be mounted at a lower front side of the interior housing 113, and have a shape to contour the jaw. The jaw rest 150 may have a groove in the center, and be made of a soft material, such as silicon, for user comfort.

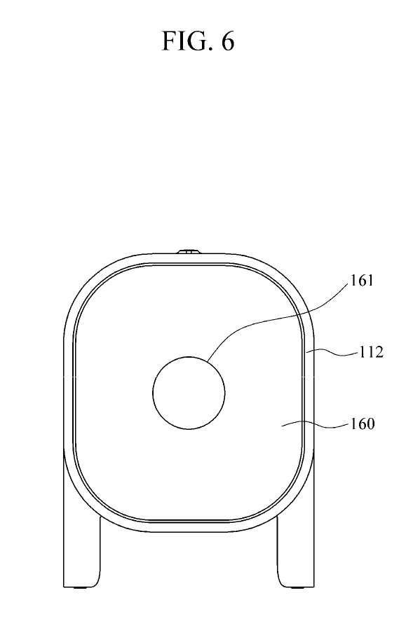

As shown in FIG. 6, the face positioning part 112 may have a face screen 160. When the user puts his/her face into the face positioning part 112, the face screen 160 covers the opening of the face positioning part 112, while enveloping the user's face but exposing the face to the darkroom 111. The face screen 160 may block light from entering the darkroom 111 when the user places the face into the face positioning part 112. Consequently, it is possible for the camera module 120 to capture images of the face in the darkroom 111 in which all external light is efficiently blocked, so that image processing efficiency can be increased during 3D face reconstruction from the captured images. In addition, a 3D face model that accurately represents the skin color of the user may be possible.

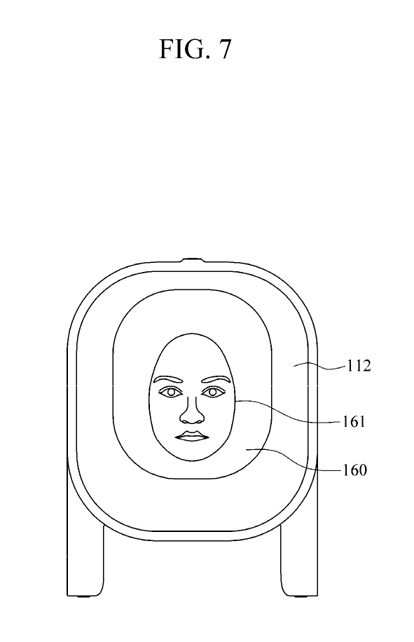

The face screen 160 may have an opening 161 with a similar shape to a human face shape, and may be made into a membrane with the outer edge attached to the edge of the opening of the face positioning part 112. The face screen 160 may be a membrane of elastic material, such as spandex. When the user pushes the face into the opening 161 of the face screen 160, the opening 161 expands and encloses tightly the face as shown in FIG. 7. Accordingly, external light is prevented from entering the darkroom 111. In another example, although not illustrated, the face screen may enclose the face, and have a zipper or other fastening component placed under the jaw, thereby being adjustable in accordance with the shape of the user's face.

According to the exemplary embodiments, an ordinary user can easily build a 3D model by capturing 3D face images using the 3D face scanning apparatus. In addition, the 3D face scanning apparatus has improved mobility due to its compact structure, and is also capable of capturing the exact skin color.

Further, according to the exemplary embodiments, it is expected that a user can produce a 3D face model of user's own face and apply the 3D face model for various product and content applications. For example, a make-up demonstration may be carried out using a 3D face model of a consumer. Also, the user can create user's own unique, personalized products by integrating the 3D face modeling and 3D printer technology, which is gaining more popularity.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A three-dimensional (3D) face scanning apparatus comprising:
a housing body configured to comprise a darkroom formed inside, and a face positioning part with an opening in front of the darkroom, allowing a user's face to be placed in the darkroom therethrough;
a camera module installed at a rear of the darkroom to capture stereo images of the user's face; and
a lighting module installed in the darkroom to illuminate the face.

2. The 3D face scanning apparatus of claim 1, wherein the housing body is configured to comprise an interior housing inside which the darkroom is formed, and an exterior housing having a first vent opening and being formed in a shape that encloses the interior housing at a distance.

3. The 3D face scanning apparatus of claim 2, wherein the exterior housing comprises support legs on left and right sides.

4. The 3D face scanning apparatus of claim 3, wherein each of the support legs comprises a handle formed thereon.

5. The 3D face scanning apparatus of claim 2, wherein the housing body comprises a rear housing installed in a rear of the exterior housing, situating the camera module, having a second vent opening, and being made of a light transmitting material.

6. The 3D face scanning apparatus of claim 1, wherein the lighting module comprises general light sources configured to emit general light into the darkroom, polarized light sources configured to emit polarized light into the darkroom, and ultraviolet (UV) light sources configured to emit UV light into the darkroom.

7. The 3D face scanning apparatus of claim 6, wherein:
the general light sources are mounted in the rear surface of the darkroom and placed above and below the camera module, and emit the general light toward a front of the darkroom,
the polarized light sources are mounted at locations corresponding to a top surface and a bottom surface of the darkroom, and emit polarized light into the darkroom, and
the UV light sources are placed at locations corresponding to left and right sides of the darkroom, and emit UV light into the darkroom from the left and right sides.

8. The 3D face scanning apparatus of claim 6, wherein:
the housing body comprises an operating part disposed on an outer surface thereof, and
the operating part comprises a general light button to switch on and off the general light sources; a polarized light source button to switch on and off the polarized light sources; a UV light source button to switch on and off the UV light sources; and a power button.

9. The 3D face scanning apparatus of claim 1, wherein the camera module comprises a plurality of cameras arranged horizontally.

10. The 3D face scanning apparatus of claim 1, further comprising:
a mirror placed on an inner rear side of the darkroom and toward the front of the darkroom, and having centrally placed guiding lines thereon.

11. The 3D face scanning apparatus of claim 1, further comprising:
a jaw rest disposed close to the face positioning part, and supporting a user's jaw.

12. The 3D face scanning apparatus of claim 1, further comprising:
a face screen configured to cover the opening of the face positioning part while enveloping the user's face, but exposing the face to the darkroom.
